(19) United States
(12) Patent Application Publication
(10) Pub. No.: US 2016/0177716 A1
(43) Pub. Date: Jun. 23, 2016

(54) Fluid Composition Using Optical Analysis and Gas Chromatography

(71) Applicant: Schlumberger Technology Corporation, Sugar Land, TX (US)

(72) Inventors: Youxiang Zuo, Burnaby (CA); Ronald E.G. van Hal, Belmont, MA (US); Jeffrey Crank, Walpole, MA (US); Adriaan Gisolf, Houston, TX (US)

(21) Appl. No.: 14/574,334

(22) Filed: Dec. 17, 2014

(51) Int. Cl. E21B 49/08; G01V 8/10

(52) U.S. Cl. CPC E21B 49/088; G01V 8/10; G01N 30/74

(57) ABSTRACT

Methods and systems are provided for determining a gas/oil ratio using gas chromatography and optical analysis of a fluid sample obtained using a fluid sampling tool. In some embodiments, a gas/oil ratio may be determined from the mass fraction of each light component of the fluid, the mass fraction of each intermediate component of the fluid, a molecular weight of each light component of the fluid, a molecular weight of each intermediate component of the fluid, the density of stock tank oil, the vapor mass fraction of the intermediate components of the fluid, and the mass fraction of the plus fraction of the fluid. In some embodiments, a gas/oil ratio may be determined from the density of stock tank oil, the vapor mole fraction of the intermediate components of the fluid, and the molecular weight of stock tank oil.

### BACKGROUND

This disclosure relates to fluid analysis and, more particularly, to determining fluid composition using downhole fluid analysis.

This disclosure relates to determination of fluid composition using downhole fluid analysis (DFA). The composition of a fluid may be determined from various measurements obtained from a fluid downhole in a well. However, composition determinations for a fluid downhole may be difficult and may not provide accurate measurements of all components of a fluid. Moreover, extracting a fluid sample to a surface laboratory to provide a detailed composition analysis may be time-consuming and may be insufficiently responsive for reservoir development, production, and management.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Embodiments of this disclosure relate to various methods and systems for determining the gas/oil ratio of a fluid using gas chromatography and optical analysis. According to some embodiments, a method for determining a gas/oil ratio of a fluid is provided that includes quantifying a plurality of components of a fluid sample from measurements obtained from a gas chromatogram adapted to receive a first portion of the fluid sample and from an optical analyzer adapted to receive a second portion of the fluid sample. The plurality of components may include light components and intermediate components. The method also includes determining a mass fraction for each light component of the plurality of components and determining a mass fraction for each intermediate component of the plurality of components. The method also includes determining a gas/oil ratio of the fluid sample from the mass fraction of each light component, the mass fraction of each intermediate component, a molecular weight of each light component, a molecular weight of each intermediate component, the density of stock tank oil, the vapor mass fraction of the intermediate components, and the mass fraction of a plus fraction determined from the fluid sample.

According to another embodiments, a method for determining a gas/oil ratio of a fluid is provided that includes quantifying a plurality of components of a fluid sample from measurements obtained from a gas chromatogram adapted to receive a first portion of the fluid sample and from an optical analyzer adapted to receive a second portion of the fluid sample. The plurality of components may include light components and intermediate components. The method includes determining a gas/oil ratio of the fluid sample from the density of stock tank oil, the vapor mole fraction of the intermediate components, and the molecular weight of stock tank oil.

According to another embodiment, a system is provided having one or more processors and a non-transitory tangible computer-readable memory coupled to the one or more processors and having executable computer code stored thereon. The code includes a set of instructions that causes one or more processors to perform the following: quantifying a plurality of components of a fluid sample from measurements obtained from a gas chromatogram adapted to receive a first portion of the fluid sample and from an optical analyzer adapted to receive a second portion of the fluid sample. The plurality of components may include light components and intermediate components. The code further includes a set of instructions that causes one or more processors to perform the following: determining a gas/oil ratio of the fluid sample from the density of stock tank oil, the vapor mole fraction of the intermediate components, and the molecular weight of stock tank oil.

### BRIEF DESCRIPTION OF THE DRAWINGS

Various aspects of this disclosure may be better understood upon reading the following detailed description and upon reference to the drawings in which:

FIG. 1 is a schematic diagram of an example drilling system having a fluid sampling tool in a drill string in accordance with an embodiment of the present disclosure;

FIG. 2 is a schematic diagram of an example fluid sampling tool deployed within a well on a wireline in accordance with an embodiment of the present disclosure;

FIG. 3 is a block diagram of components of an example fluid sampling tool operated by a controller in accordance with an embodiment of the present disclosure;

FIG. 4 is a block diagram of an example process for determining gas/oil ratio in accordance with an embodiment of the present disclosure; and

FIG. 5 is a block diagram of an example processing system in accordance with an embodiment of the present disclosure.

### DETAILED DESCRIPTION

Described herein are various implementations related to determining fluid composition using gas chromatography and optical analysis of a fluid sample. In some embodiments, a fluid sample may be obtained using a fluid sampling tool having a gas chromatograph and an optical analyzer. Gas chromatography measurements and optical measurements may be obtained and used to determine a composition of the fluid. The fluid composition may include, for example, light components, intermediate components, and a plus fraction that includes heavier components. In some embodiments, a gas/oil ratio (GOR) of the fluid may be determined from the fluid sample from the mass fraction of each light component, the mass fraction of each intermediate component, a molecular weight of each light component, a molecular weight of each intermediate component, the density of stock tank oil, the vapor mass fraction of the intermediate components, and the mass fraction of the plus fraction. In some embodiments, a gas/oil ratio of the fluid may be determined from the density of stock tank oil, the vapor mole fraction of the intermediate components, and the molecular weight of stock tank oil.

These and other embodiments of the disclosure will be described in more detail through reference to the accompanying drawings in the detailed description of the disclosure that follows. This brief introduction, including section titles and corresponding summaries, is provided for the reader's convenience and is not intended to limit the scope of the claims or the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

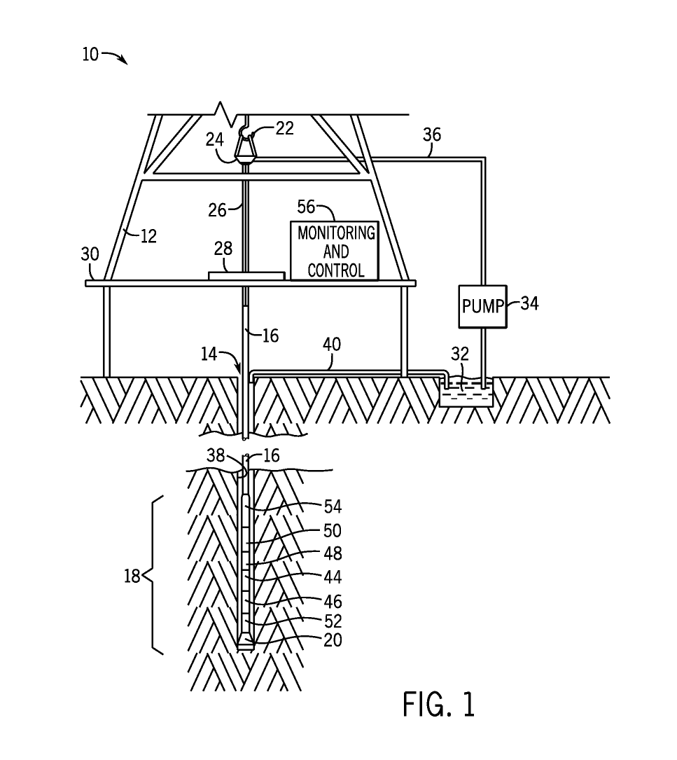

More specifically, a drilling system 10 is depicted in FIG. 1 in accordance with one embodiment. While certain elements of the drilling system 10 are depicted in this figure and generally discussed below, it will be appreciated that the drilling system 10 may include other components in addition to, or in place of, those presently illustrated and discussed. As depicted, the system 10 can include a drilling rig 12 positioned over a well 14. Although depicted as an onshore drilling system 10, it is noted that the drilling system could instead be an offshore drilling system. The drilling rig 12 can support a drill string 16 that includes a bottomhole assembly 18 having a drill bit 20. The drilling rig 12 can rotate the drill string 16 (and its drill bit 20) to drill the well 14.

The drill string 16 can be suspended within the well 14 from a hook 22 of the drilling rig 12 via a swivel 24 and a kelly 26. Although not depicted in FIG. 1, the skilled artisan will appreciate that the hook 22 can be connected to a hoisting system used to raise and lower the drill string 16 within the well 14. As one example, such a hoisting system could include a crown block and a drawworks that cooperate to raise and lower a traveling block (to which the hook 22 is connected) via a hoisting line. The kelly 26 can be coupled to the drill string 16, and the swivel 24 can allow the kelly 26 and the drill string 16 to rotate with respect to the hook 22. In the presently illustrated embodiment, a rotary table 28 on a drill floor 30 of the drilling rig 12 can be constructed to grip and turn the kelly 26 to drive rotation of the drill string 16 to drill the well 14. In other embodiments, however, a top drive system could instead be used to drive rotation of the drill string 16.

During operation, drill cuttings or other debris may collect near the bottom of the well 14. Drilling fluid 32, also referred to as drilling mud, can be circulated through the well 14 to remove this debris. The drilling fluid 32 may also clean and cool the drill bit 20 and provide positive pressure within the well 14 to inhibit formation fluids from entering the wellbore. In FIG. 1, the drilling fluid 32 can be circulated through the well 14 by a pump 34. The drilling fluid 32 can be pumped from a mud pit (or some other reservoir, such as a mud tank) into the drill string 16 through a supply conduit 36, the swivel 24, and the kelly 26. The drilling fluid 32 can exit near the bottom of the drill string 16 (e.g., at the drill bit 20) and can return to the surface through the annulus 38 between the wellbore and the drill string 16. A return conduit 40 can transmit the returning drilling fluid 32 away from the well 14. In some embodiments, the returning drilling fluid 32 can be cleansed (e.g., via one or more shale shakers, desanders, or desilters) and reused in the well 14. The drilling fluid 32 may include an oil-based mud (OBM) that may include synthetic muds, diesel-based muds, or other suitable muds.

In addition to the drill bit 20, the bottomhole assembly 18 can also include various instruments that measure information of interest within the well 14. For example, as depicted in FIG. 1, the bottomhole assembly 18 can include a logging-while-drilling (LWD) module 44 and a measurement-while-drilling (MWD) module 46. Both modules can include sensors, housed in drill collars, that can collect data and enable the creation of measurement logs in real-time during a drilling operation. The modules could also include memory devices for storing the measured data. The LWD module 44 can include sensors that measure various characteristics of the rock and formation fluid properties within the well 14. Data collected by the LWD module 44 could include measurements of gamma rays, resistivity, neutron porosity, formation density, sound waves, optical density, and the like. The MWD module 46 can include sensors that measure various characteristics of the bottomhole assembly 18 and the wellbore, such as orientation (azimuth and inclination) of the drill bit 20, torque, shock and vibration, the weight on the drill bit 20, and downhole temperature and pressure. The data collected by the MWD module 46 can be used to control drilling operations. The bottomhole assembly 18 can also include one or more additional modules 48, which could be LWD modules, MWD modules, or some other modules. It is noted that the bottomhole assembly 18 is modular, and that the positions and presence of particular modules of the assembly could be changed as desired. Further, as discussed in detail below, one or more of the modules 44, 46, and 48 can be or can include a fluid sampling tool configured to obtain a sample of a fluid from a subterranean formation and perform downhole fluid analysis to measure various properties of the sampled fluid. These properties may include an estimated density and/or optical density of the OBM filtrate, the sampled fluid, and other fluids. These and other estimated properties may be determined within or communicated to the LWD module 44, such as for subsequent utilization as input to various control functions and/or data logs.

The bottomhole assembly 18 can also include other modules. As depicted in FIG. 1 by way of example, such other modules can include a power module 50, a steering module 52, and a communication module 54. In one embodiment, the power module 50 can include a generator (such as a turbine) driven by flow of drilling mud through the drill string 16. In other embodiments, the power module 50 could also or instead include other forms of power storage or generation, such as batteries or fuel cells. The steering module 52 may include a rotary-steerable system that facilitates directional drilling of the well 14. The communication module 54 can enable communication of data (e.g., data collected by the LWD module 44 and the MWD module 46) between the bottomhole assembly 18 and the surface. In one embodiment, the communication module 54 can communicate via mud pulse telemetry, in which the communication module 54 uses the drilling fluid 32 in the drill string as a propagation medium for a pressure wave encoding the data to be transmitted.

The drilling system 10 can also include a monitoring and control system 56. The monitoring and control system 56 can include one or more computer systems that enable monitoring and control of various components of the drilling system 10. The monitoring and control system 56 can also receive data from the bottomhole assembly 18 (e.g., data from the LWD module 44, the MWD module 46, and the additional module 48) for processing and for communication to an operator, to name just two examples. While depicted on the drill floor 30 in FIG. 1, it is noted that the monitoring and control system 56 could be positioned elsewhere, and that the system 56 could be a distributed system with elements provided at different places near or remote from the well 14.

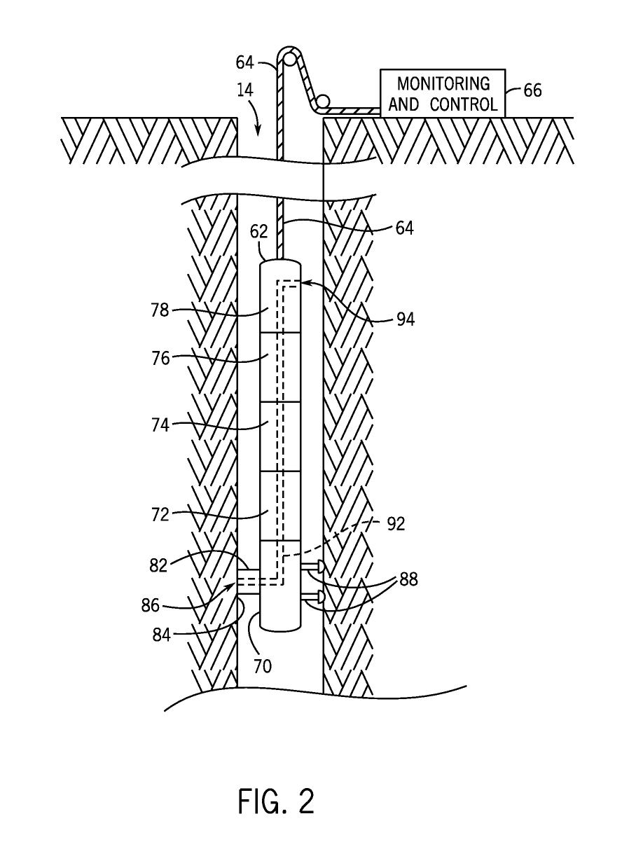

Another example of using a downhole tool for formation testing within the well 14 is depicted in FIG. 2. In this embodiment, a fluid sampling tool 62 can be suspended in the well 14 on a cable 64. The cable 64 may be a wireline cable with at least one conductor that enables data transmission between the fluid sampling tool 62 and a monitoring and control system 66. The cable 64 may be raised and lowered within the well 14 in any suitable manner. For instance, the cable 64 can be reeled from a drum in a service truck, which may be a logging truck having the monitoring and control system 66. The monitoring and control system 66 can control movement of the fluid sampling tool 62 within the well 14 and can receive data from the fluid sampling tool 62. In a similar fashion to the monitoring and control system 56 of FIG. 1, the monitoring and control system 66 may include one or more computer systems or devices and may be a distributed computing system. The received data can be stored, communicated to an operator, or processed, for instance. While the fluid sampling tool 62 is here depicted as being deployed by way of a wireline, in some embodiments, the fluid sampling tool 62 (or at least its functionality) can be incorporated into or as one or more modules of the bottomhole assembly 18, such as the LWD module 44 or the additional module 48.

The fluid sampling tool 62 can take various forms. While it is depicted in FIG. 2 as having a body including a probe module 70, one or more fluid analysis modules 72, a pump module 74, a power module 76, and a fluid storage module 78, the fluid sampling tool 62 may include different modules in other embodiments. The probe module 70 can include a probe 82 that may be extended (e.g., hydraulically driven) and pressed into engagement against a wall 84 of the well 14 to draw fluid from a formation into the fluid sampling tool 62 through an intake 86. As depicted, the probe module 70 can also include one or more setting pistons 88 that may be extended outwardly to engage the wall 84 and push the end face of the probe 82 against another portion of the wall 84. In some embodiments, the probe 82 can include a sealing element or packer that isolates the intake 86 from the rest of the wellbore. In other embodiments, the fluid sampling tool 62 could include one or more inflatable packers that can be extended from the body of the fluid sampling tool 62 to circumferentially engage the wall 84 and isolate a region of the well 14 near the intake 86 from the rest of the wellbore. In such embodiments, the extendable probe 82 and setting pistons 88 could be omitted and the intake 86 could be provided in the body of the fluid sampling tool 62, such as in the body of a packer module housing an extendable packer.

The pump module 74 can draw the sampled formation fluid into the intake 86, through a flowline 92, and then either out into the wellbore through an outlet 94 or into a storage container (e.g., a bottle within fluid storage module 78) for transport back to the surface when the fluid sampling tool 62 is removed from the well 14. The one or more fluid analysis modules 72, which may also be referred to as a fluid analyzer 72 or a downhole fluid analysis (DFA) module, can include one more modules for measuring properties of the sampled formation fluid, and the power module 76 provides power to electronic components of the fluid sampling tool 62.

In some embodiments, the one or more fluid analysis modules 72 may include an optical analysis module adapted to receive at least a portion of the fluid sample. The optical analysis module may determine an optical property of the fluid sample and to provide an output signal related to or otherwise indicative of the optical property. In such embodiments, the optical analysis module may perform near-infrared optical absorption spectrometry and fluorescence emission measurements for analyzing fluids as they flow through the tool 62. The optical analysis module may be used to determine gas-fraction concentrations and to identify fluid types, respectively.

In some embodiments, the one or more fluids analysis modules 72 of the tool 62 include a gas chromatography (GC) module. The GC module is configured to determine a composition of the fluid sample and to provide an output signal indicative of the determined composition. The GC module may produce what may be referred to as a “gas chromatogram.” For the example embodiment using gas chromatography, the gas chromatography module 116 is configured to obtain a chromatogram of sampled formation fluids available within the flowline 92 portion of the tool 62. An example of such a device is described in U.S. Pub. App. No. 2010/0018287, entitled “Wireline Downhole Gas Chromatograph and Downhole Gas Chromatography Method,” and U.S. Pat. No. 7,384,453, entitled “Self Contained Chromatography System,” each assigned to Schlumberger Technology Corporation and incorporated herein by reference in its entirety. In some embodiments, the GC module may output composition up to C9, e.g., hydrocarbon fractions C1 through C8. In some embodiments, the GC module may output composition up to C30, e.g., hydrocarbon fractions C1 through C29. Additionally, the GC module may also measure N2, CO2, H2S, and saturated and aromatic hydrocarbons and abundance ratios. In some embodiments, the GC module of the fluid analysis tool 62 described above may be insensitive to mud filtrate contamination in a sampled fluid by providing analysis of hydrocarbon fractions C1 through C8. Additionally, the GC module of the fluid analysis tool 62 may provide relatively fast profiling of fluid composition ratio changes versus depth.

In some embodiments, the one or more fluid analysis modules 72 may include a downhole pressure-volume-temperature PVT unit and may obtain microfluidic measurements of the sampled fluid. Embodiments of the tool 62 and fluid analysis modules 72 may include any one of or combination of the modules described above. For example, in some embodiments, the tool 62 may include an optical analysis module and a gas chromatography module.

The drilling and wireline environments depicted in FIGS. 1 and 2 are examples of environments in which a fluid sampling tool may be used to facilitate analysis of a downhole fluid. The presently disclosed techniques, however, could be implemented in other environments as well. For instance, the fluid sampling tool 62 may be deployed in other manners, such as by a slickline, coiled tubing, or a pipe string.

Accordingly, the embodiments described above and illustrated in FIGS. 1 and 2 may enable fluid sampling at different depths in the wellbore of the well 14. In some embodiments, systems depicted in FIGS. 1 and 2 may perform multiple fluid measurements by downhole sampling of reservoir fluid at one or more measurement stations (which may include or be referred to as downhole fluid analysis (DFA) stations) within the wellbore, conduct downhole fluid analysis of one or more reservoir fluid samples for each measurement station (including compositional analysis such as estimating concentrations of a plurality of compositional components of a given sample as well as other fluid properties) and, in some embodiments, relate the downhole fluid analysis to an Equation of State (EoS) model of the thermodynamic behavior of the fluid in order to characterize the reservoir fluid at different locations within the reservoir.

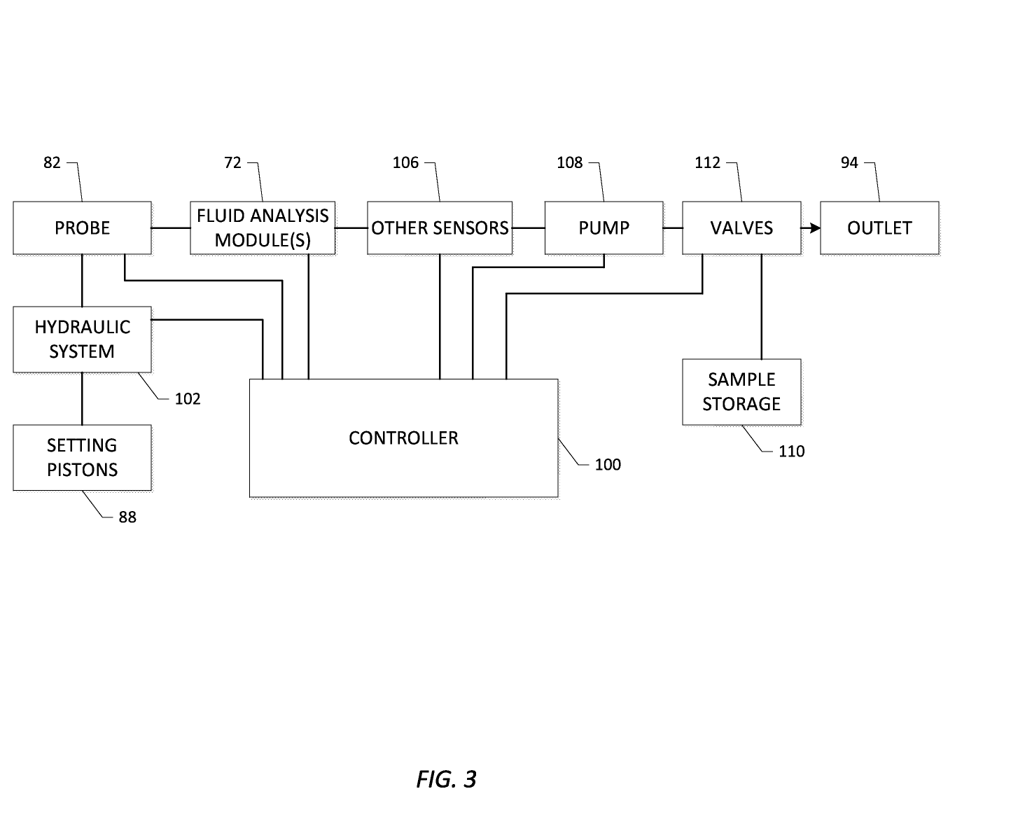

Additional details as to the construction and operation of the fluid sampling tool 62 may be better understood through reference to FIG. 3. As shown in this figure, various components for carrying out functions of the fluid sampling tool 62 can be connected to a controller 100. The various components can include a hydraulic system 102 connected to the probe 82 and the setting pistons 88, the one or more fluid analysis modules 72 discussed above, one or more other sensors 106, a pump 108, and valves 112 for diverting sampled fluid into storage devices 110 rather than venting it through the outlet 94. The controller 100 may include or be coupled to an operator interface (not shown) that provides logs of predicted formation fluid properties that are accessible to an operator.

In operation, the hydraulic system 102 can extend the probe 82 and the setting pistons 88 to facilitate sampling of a formation fluid through the wall 84 of the well 14. It also can retract the probe 82 and the setting pistons 88 to facilitate subsequent movement of the fluid sampling tool 62 within the well. The one or more fluid analysis modules 72 can measure properties of the sampled formation fluid in accordance with the embodiments described above. For example, an optical analysis module may measure optical properties such as optical densities (absorbance) of the sampled formation fluid at different wavelengths of electromagnetic radiation. Using the optical densities, the composition of a sampled fluid (e.g., volume fractions of its constituent components) can be determined. In another example, as described above, a gas chromatography module may determine composition of the fluid sample and provide an output signal indicative of the determined composition. Other sensors 106 can be provided in the fluid sampling tool 62 (e.g., as part of the probe module 70 or the fluid analysis module 72) to take additional measurements related to the sampled fluid. In various embodiments, these additional measurements could include reservoir pressure and temperature, live fluid density, live fluid viscosity, electrical resistivity, saturation pressure, and fluorescence, to name several examples. In some embodiments, as mentioned above, some or all of other sensors 106 may be incorporated into a DFA module (e.g., such as in a PVT unit) of the fluid sampling tool 62.

Any suitable pump 108 may be provided in the pump module 74 to enable formation fluid to be drawn into and pumped through the flowline 92 in the manner discussed above. Storage devices 110 for formation fluid samples can include any suitable vessels (e.g., bottles) for retaining and transporting desired samples within the fluid sampling tool 62 to the surface. Both the storage devices 110 and the valves 112 may be provided as part of the fluid storage module 78.

In the embodiment depicted in FIG. 3, the controller 100 can facilitate operation of the fluid sampling tool 62 by controlling various components. Specifically, the controller 100 can direct operation (e.g., by sending command signals) of the hydraulic system 102 to extend and retract the probe 82 and the setting pistons 88 and of the pump 108 to draw formation fluid samples into and through the fluid sampling tool. The controller 100 can also receive data from the fluid analysis module 72 and the other sensors 106. This data can be stored by the controller 100 or communicated to another system (e.g., the monitoring and control system 56 or 66) for analysis. In some embodiments, the controller 100 is itself capable of analyzing the data it receives from the fluid analysis module 72 and the other sensors 106. The controller 100 can also operate the valves 112 to divert sampled fluids from the flowline 92 into the storage devices 110.

In some embodiments, the fluid sampling tool 62 described above may be used in a determination of gas/oil ratio of a fluid reservoir fluid. However, in such embodiments, fluid compositions obtained from an optical analysis module may be affected by the measurement capabilities of the optical analysis module. For example, the measurement accuracy of C1 (methane) fractions may be affected by factors such as benzene-toluene-xylene (BTX) content. In such instances, a high BTX content may result in a overestimation of some fluid properties such as GOR due to, for example, higher values for C2 (ethane) and other hydrocarbon fractions such as C3, C4, and C5. Furthermore, other fractions such as nitrogen may not be accounted for.

As described further below, the GOR for a reservoir fluid may be determined using both GC measurements and optical measurements from fluid analysis modules of the fluid sampling tool 62. For example, the GC measurements may provide information about the ratio between methane, ethane, propane, n- and i-butanes, neo-pentane, and CO2. The ratio of all these components, in combination with the borehole pressure, may be used to determine a combined optical absorption spectrum for these components.

For a live reservoir fluid, the single stage flash GOR may be defined as the ratio of the volume of the flashed gas that comes out of the live fluid solution to the volume of the flashed oil (also referred to as “stock tank oil (STO)”) at standard conditions. In some embodiments, standard conditions may refer to 60° F. and 14.7 psia. Accordingly, the GOR may be defined according to Equation 1 below:

$$G O R = \frac{{V}_{g}}{{V}_{sto}} \qquad ( 1 )$$

Where GOR is the gas/oil ratio of the fluid, V_{gas} is the flashed gas volume, and V_{STO} is the volume of flashed STO at standard conditions.

In some embodiments, the flashed gas may include CO2, N2, H2S, C1, C2, C3, n-C4, i-C4, n-C5, neo-C5, iso-C5, C6, methylcyclopentane, cyclohexane, C7, benzene, toluene, and smaller amounts of C8, o-xylene, and ethyl-benzene. In such embodiments, the flashed oil may include components heavier than C2, e.g., C3 and higher molecular weight components. Assuming the ideal gas law is valid at standard conditions, the flashed gas volume at standard conditions may be determined. In some embodiments, CO2, N2, H2S, C1, and C2 components may be referred to as “light components.” In some embodiments, C3 through C7 components may be referred to as “intermediate components” and C8+ may be referred to as “heavy components.” In other embodiments, C3-C8 may be referred to as “intermediate components” and C9+ may be referred to as “heavy components.”

Light components of the fluid, such as CO2, N2, H2S, C1, and C2, may be assumed to be completely vaporized in the gas phase at standard conditions. Intermediate components, such as C3, n-C4, i-C4, n-C5, neo-C5, i-C5, C6, methyl-cyclopentane, cyclohexane, C7, benzene, and toluene, may be assumed to be distributed in the gas and oil phases. C8, o-xylene, and ethyl-benzene may be ignored in the vapor phase and assumed to be in the oil phase. Heavy components, such as C8 and heavier, may be assumed to be completely present in the oil phase. Based on 1 mass unit of a reservoir fluid, the flashed gas volume V_{g} at standard conditions may be determined according to Equation 2:

$${V}_{g} = \frac{{RT}_{std}}{{P}_{std}} ( {\sum }_{l} \frac{{m}_{l}}{{M}_{l}} + {f}_{g} {\sum }_{i} \frac{{m}_{i}}{{M}_{i}} ) = 23.69 ( {\sum }_{l} \frac{{m}_{l}}{{M}_{l}} + {f}_{g} {\sum }_{i} \frac{{m}_{i}}{{M}_{i}} ) \qquad ( 2 )$$

Where m₁ is the mass fraction of the light components, M₁ is the molecular weight of the light components, mᵢ is the mass fraction of the intermediate components, Mᵢ is the molecular weight of the intermediate components, R is the ideal gas constant, T_{std} is the standard temperature, P_{std} is the standard pressure, f_{g} is the vapor mass fraction of the intermediate components, and 23.69 is the number of liters that one gram-mole of any gas occupies at standard conditions. As will be appreciated, the molecular weight of the light components M₁ and the molecular weight of the intermediate components Mᵢ may be determined from reference sources. The mass fraction of the light components mₗ and the mass fraction of the intermediate components mᵢ may be determined from the downhole GC measurements and the downhole optical measurements.

The volume of flashed STO at standard conditions V_{STO} may be determined according to Equation 3 as follows:

$${V}_{sto} = \frac{( 1 - {f}_{g} ) {\sum }_{i} {m}_{i} + {m}_{n +}}{{d}_{sto}} \qquad ( 3 )$$

Where dₛₜₒ is the stock tank oil (STO) density at standard conditions, mₙ₊ is the mass fraction of C8+ or, in some embodiments, C9+. The mass fraction mₙ₊ may be determined from the downhole GC measurements and the downhole optical measurements. Using Equations 1-3, GOR may be determined according to Equation 4 below:

$$GOR = \frac{23.69 {d}_{sto} ( {\sum }_{l} \frac{{m}_{l}}{{M}_{l}} + {f}_{g} {\sum }_{i} \frac{{m}_{i}}{{M}_{i}} )}{( 1 - {f}_{g} ) {\sum }_{i} {m}_{i} + {m}_{n +}} \qquad ( 4 )$$

As described further below, vapor mass fraction of the intermediate components f_{g} and the stock tank oil (STO) density at standard conditions dₛₜₒ for Equation 4 may be estimated using any one of or combination of suitable techniques.

In some embodiments, based on 1 mole of the reservoir fluid, GOR may also be determined according to Equation 5 below:

$$GOR = \frac{{V}_{g}}{{V}_{sto}} = \frac{23.69 {n}_{g}}{\frac{( 1 - {n}_{g} ) {MW}_{sto}}{{d}_{sto}}} = \frac{23.69 {n}_{g} {d}_{sto}}{( 1 - {n}_{g} ) {M}_{sto}} \qquad ( 5 )$$

Where n_{g} is the vapor mole fraction of the intermediate components and mₛₜₒ is the molecular weight of stock tank oil. As described further below, the vapor mole fraction of the intermediate components n_{g}, the molecular weight of stock tank oil Mₛₜₒ, and the stock tank oil (STO) density at standard conditions dₛₜₒ for Equation 5 may be estimated using any one or combination of suitable techniques.

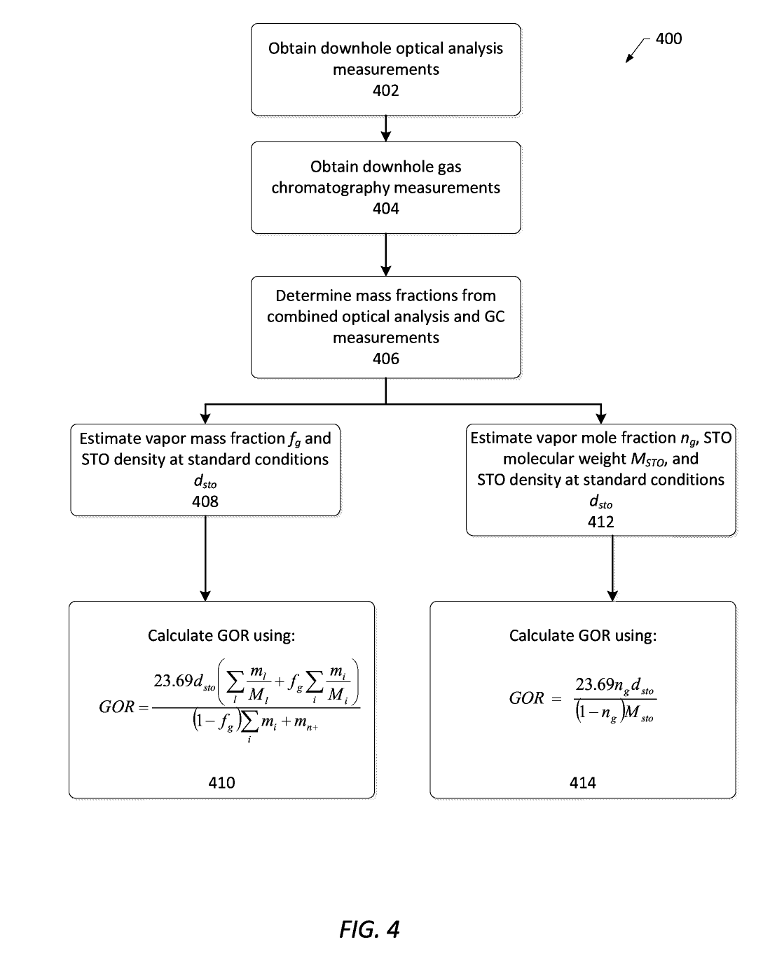

FIG. 4 depicts an example process 400 for determining a gas/oil ratio (GOR) in accordance with an embodiment of the disclosure. Initially, downhole optical analysis measurements of a fluid may be obtained from a measurement station (block 402). Additionally, downhole gas chromatography measurements of the fluid may also be obtained from the measurement station or, in some embodiments, a different measurement station (block 404). Next, mass fractions for components of the fluid may be determined from the optical analysis measurements and GC measurements (block 406). For example, in some embodiments, the mass fractions of light components such as CO2, N2, H2S, C1, and C2 may be determined. Similarly, in some embodiments, the mass fractions of intermediate components such as C3, C4, C5, C6, C7, and C8 may be determined.

In some embodiments, the vapor mass fraction f_{g} of the intermediate components and the stock tank oil (STO) density at standard conditions dₛₜₒ may be estimated (block 408). Accordingly, using Equation 4, the GOR for the fluid may be calculated from the vapor mass fraction f_{g} of the intermediate components, the stock tank oil (STO) density at standard conditions dₛₜₒ, the mass fractions of the light components mₗ, the molecular weights of the light components Mₗ, the mass fractions of the intermediate components mᵢ, and the molecular weights of the intermediate components Mᵢ (block 410).

In some embodiments, the vapor mole fraction n_{g} of the intermediate components, the stock tank oil (STO) density at standard conditions dₛₜₒ, and the STO molecular weight Mₛₜₒ may be estimated (block 412). Accordingly, using Equation 5, the GOR for the fluid may be calculated from the vapor mole fraction n_{g} of the intermediate components, the stock tank oil (STO) density at standard conditions dₛₜₒ, and the molecular weight of stock tank oil Mₛₜₒ (block 414).

As noted above, in some embodiments, the vapor mass fraction f_{g} of the intermediate components and the stock tank oil (STO) density at standard conditions dₛₜₒ in Equation 4 may be estimated using suitable techniques. Similarly, the vapor mole fraction n_{g} of the intermediate components, the stock tank oil (STO) density at standard conditions dₛₜₒ, and the STO molecular weight in Equation 5 may be estimated using the same techniques. Discussed in detail below are three example techniques for estimating the vapor mass fraction f_{g} of the intermediate components, the vapor mole fraction n_{g} of the intermediate components, the stock tank oil (STO) density at standard conditions dₛₜₒ, the STO molecular weight Mₛₜₒ, or any combination thereof. Embodiments of the disclosure may use any one of or combination of the estimation techniques described below. Moreover, in some embodiments, additional estimation techniques or combinations thereof may be used to estimate the parameters described above.

In some embodiments, the vapor mass fraction f_{g} of the intermediate components, the vapor mole fraction n_{g} of the intermediate components, the stock tank oil (STO) density at standard conditions dₛₜₒ, the STO molecular weight Mₛₜₒ, or any combination thereof may be estimated using an artificial neural network (ANN), such as described in U.S. Pat. No. 7,966,273, entitled “Predicting formation fluid property through downhole fluid analysis using artificial neural network,” assigned to Schlumberger Technology Corporation and incorporated herein by reference in its entirety. The ANN may be used to estimate the parameters described above and perform the flash calculation.

In some embodiments, the vapor mass fraction f_{g} of the intermediate components, the vapor mole fraction n_{g} of the intermediate components, the stock tank oil (STO) density at standard conditions dₛₜₒ, the STO molecular weight Mₛₜₒ, or any combination thereof may be estimated using an equilibrium constant technique. The equilibrium constant for a component i may be defined as the ratio of the vapor mole fraction to liquid mole fraction, as described below in Equation 6:

$${K}_{i} = \frac{{y}_{i}}{{x}_{i}} \qquad ( 6 )$$

Where Kᵢ is the equilibrium constant, yᵢ is the vapor mole fraction and xᵢ is the liquid mole fraction. For a reservoir fluid, the correlation described in Hoffmann et al. “Equilibrium Constant for a Gas-Condensate System”, Petroleum Transactions, AIME, vol. 198, 1-10 (1953), may be used and is described below in Equation 7:

$${log}_{10} ( {K}_{i} {P}_{std} ) = a + b \frac{{log}_{10} ( \frac{{P}_{ci}}{{P}_{std}} ) ( \frac{1}{{T}_{bi}} - \frac{1}{{T}_{std}} )}{( \frac{1}{{T}_{bi}} - \frac{1}{{T}_{ci}} )} \qquad ( 7 )$$

Where P_{std} equals 14.7 psia, T_{std} equals 519.67° R, T_{c} is the critical temperature (in ° R), P_{c} is the critical pressure (in psia), T_{b} is the normal boiling temperature (in ° R), and a and b are turning parameters. The critical temperature T_{c}, the critical pressure P_{c}, and the normal boiling temperature T_{b} may be obtained from reference materials. For example, Table 1 below lists these properties for various components:

TABLE 1
Component physical properties

| Component | M (g/mol) | P_{c} (psia) | T_{c} (° R) | T_{b} (° R) | SG (g/cm³) |
|---|---|---|---|---|---|
| CO2 | 44.01 | 1070.60 | 547.50 | 350.50 | |
| H2S | 34.08 | 1300.00 | 672.40 | 383.00 | |
| N2 | 28.01 | 492.30 | 227.00 | 139.20 | |
| C1 | 16.04 | 667.00 | 343.00 | 201.00 | |
| C2 | 30.07 | 706.60 | 549.60 | 332.20 | |
| C3 | 44.10 | 616.10 | 665.70 | 416.00 | 0.5825 |
| i-C4 | 58.12 | 529.10 | 734.70 | 470.60 | 0.5949 |
| n-C4 | 58.12 | 550.60 | 765.20 | 490.80 | 0.6141 |
| i-C5 | 72.15 | 490.20 | 828.70 | 541.80 | 0.6163 |
| n-C5 | 72.15 | 488.80 | 845.50 | 556.60 | 0.6217 |
| C6 | 84.00 | 436.60 | 913.50 | 615.50 | 0.6850 |
| Mcyclo-C5 | 84.16 | 548.90 | 959.00 | 620.90 | 0.7445 |
| Benzene | 78.11 | 710.00 | 1011.70 | 635.80 | 0.8730 |
| Cyclo-C6 | 84.16 | 591.00 | 996.40 | 637.00 | 0.7731 |
| C7 | 96.00 | 297.40 | 1089.20 | 716.30 | 0.7220 |
| Mcyclo-C6 | 98.19 | 503.50 | 1029.90 | 673.30 | 0.7659 |
| Toluene | 92.14 | 595.80 | 1065.20 | 690.80 | 0.8639 |
| C8 | 107.00 | 296.10 | 1125.10 | 764.80 | 0.7450 |
| C2-Benzene | 106.17 | 523.40 | 1110.90 | 736.80 | 0.8636 |
| m&p-Xylene | 106.17 | 511.40 | 1109.90 | 741.40 | 0.8585 |
| o-Xylene | 106.17 | 541.30 | 1134.50 | 751.60 | 0.8759 |
| C9 | 121.00 | 286.30 | 1163.00 | 853.80 | 0.7640 |

Because light components (e.g., CO2, N2, H2S, C1, C2) may be absent in the liquid phase at standard conditions, very large equilibrium constants may be assigned to the light components. In contrast, because heavy components (e.g., C8+ or C9+) may be absent in the vapor phase at standard conditions, very small (or zero) equilibrium constants may be assigned to the heavy components. At standard conditions, a=10.22 and b=1.15 may be used for all other components. Parameters a and b may be updated from updated data.

For Cₙ₊, the equilibrium constant may be determined according to Equation 8 below:

K_{Cn+}=0.1K_{Cn} (8)

Based on 1 mole of reservoir fluid with a mole fraction z, the mass balance equations are Equations, 9, 10, and 11 as follows:

$$\begin{matrix}{z}_{i} = {n}_{g} {y}_{i} + ( 1 - {n}_{g} ) {x}_{i} = {n}_{g} {K}_{i} {x}_{i} + ( 1 - {n}_{g} ) {x}_{i} & ( 9 ) \\ {x}_{i} = \frac{{z}_{i}}{{n}_{g} ( {K}_{i} - 1 ) + 1} & ( 10 ) \\ {y}_{i} = \frac{{z}_{i} {K}_{i}}{{n}_{g} ( {K}_{i} - 1 ) + 1} & ( 11 )\end{matrix}$$

As the sum of y, and x, should equal one, the Rachford-Rice equation may be derived, as described below in Equation 12:

$${\sum }_{i} {y}_{i} - {\sum }_{i} {x}_{i} = {\sum }_{i} \frac{{z}_{i} ( {K}_{i} - 1 )}{{n}_{g} ( {K}_{i} - 1 ) + 1} = 0 \qquad ( 12 )$$

Equation 12 may be solved using the Newton method to obtain n_{g}, x, and y. The molecular weight of the gas may be expressed according to Equation 13 as follows:

$${M}_{g} = {\sum }_{i} {y}_{i} {M}_{i} \qquad ( 13 )$$

Similarly, the molecular weight of the oil may be expressed according to Equation 14 as follows:

$${M}_{sto} = {\sum }_{i} {x}_{i} {M}_{i} \qquad ( 14 )$$

In some embodiments, the molecular weight of the Cn+ (e.g., C8+) fraction may be determined according to Equation 15 as follows:

MW_{C8+}=812.8GOR^{-0.168175}+14 (15)

In other embodiments, the molecular weight of the Cn+ fraction may be calculated using other suitable correlations. In some embodiments, the specific gravity (density) of the Cn+ (e.g., C8+) fraction may be determined according to Equation 16 as follows:

SG_{C8+}=0.124151n(MW_{C8+})+0.172 (16)

In other embodiments, the specific gravity of the Cn+ fraction may be calculated using other suitable correlations. The vapor mass fraction f_{g} of the intermediate components may be estimated by first performing the flash calculation at standard conditions. The mass fractions of the intermediate components may be converted to mole fractions using the molecular weight, and the flash calculation may be performed to determine n_{g}, y, and x. The mole fraction for the intermediate components may be normalized using Equations 17 and 18 described below:

$$\begin{matrix}{y}_{i} = \frac{{y}_{i}}{{\sum }_{k} {y}_{k}} & ( 17 ) \\ {x}_{i} = \frac{{x}_{i}}{{\sum }_{k} {x}_{k}} & ( 18 )\end{matrix}$$

The molecular weights for the intermediate components may be determined using Equations 19 and 20 described below:

$$\begin{matrix}{M}_{g} = {\sum }_{k} {y}_{k} {M}_{k} & ( 19 ) \\ {M}_{liquid} = {\sum }_{k} {x}_{k} {M}_{k} & ( 20 )\end{matrix}$$

The vapor mole fraction n_{g} for the intermediate components may be converted to the vapor mass fraction f_{g} using Equation 21 as follows:

$${f}_{g} = \frac{{n}_{g} {M}_{g}}{{n}_{g} {M}_{g} + ( 1 - {n}_{g} ) {M}_{liquid}} \qquad ( 21 )$$

The STO density dₛₜₒ may be estimated according to Equations 22 and 23 as follows:

$$\begin{matrix}\frac{1}{{d}_{sto}} = \frac{{w}_{i}}{{SG}_{i}} & ( 22 ) \\ {w}_{i} = \frac{{x}_{i} {M}_{i}}{{\sum }_{j} {x}_{j} {M}_{j}} & ( 23 )\end{matrix}$$

In some embodiments, instead of using Equations 22 and 23, the STO density dₛₜₒ may also be estimated using the ANN technique mentioned above.

Additionally, in some embodiments, the vapor mass fraction f_{g} of the intermediate components, the vapor mole fraction n_{g} of the intermediate components, the stock tank oil (STO) density at standard conditions dₛₜₒ, the STO molecular weight Mₛₜₒ, or any combination thereof may be estimated using an Equation of State (EoS), e.g., the Peng-Robinson EoS or the Soave-Redlich-Kwong EoS. In such embodiments, the single-state flash calculation may be performed using a cubic EoS. In some embodiments, the Cn+ fraction and cubic EoS for a reservoir fluid may be determined according to the techniques described in described in U.S. Pat. No. 7,920,970, entitled “Methods and apparatus for characterization of petroleum fluid and applications thereof,” assigned to Schlumberger Technology Corporation and incorporated herein by reference in its entirety. In some embodiments, the parameters for the EoS may be adjusted to match the fluid saturation pressure measured downhole and live fluid density. The EoS may then be used to perform the single stage flash calculation to obtain the vapor mass fraction f_{g} of the intermediate components, the vapor mole fraction n_{g} of the intermediate components, the stock tank oil (STO) density at standard conditions dₛₜₒ, the STO molecular weight Mₛₜₒ (and, in some embodiments, the molecular weight of the flashed gas M_{g}) to then determine GOR.

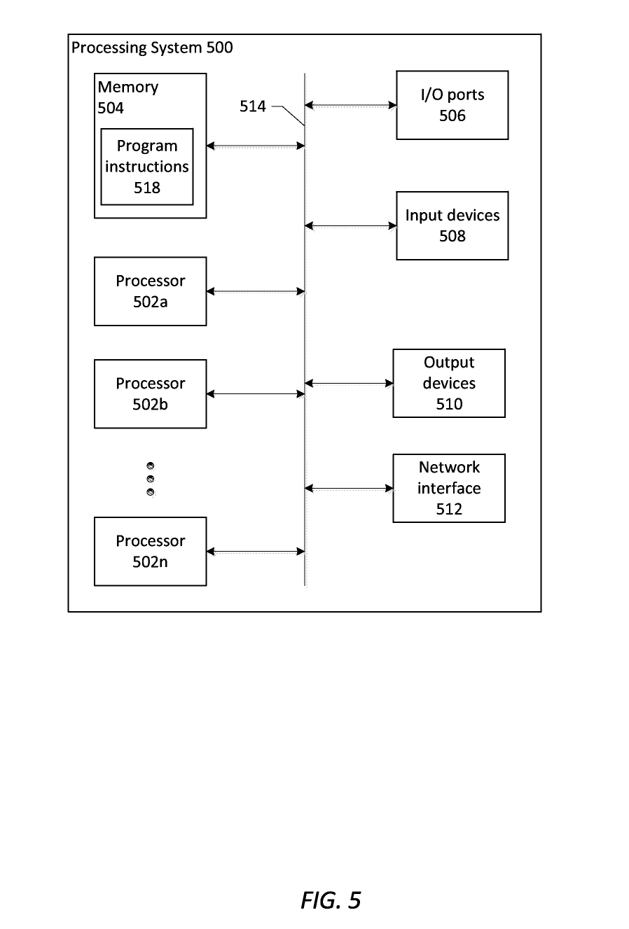

FIG. 5 is a block diagram of further details of an example processing system 500 (e.g., processing system 38) that may execute example machine-readable instructions used to implement one or more of processes described herein and, in some embodiments, to implement a portion of one or more of the example downhole tools described herein. The processing system 1000 may be or include, for example, controllers (e.g., controller 100), special-purpose computing devices, servers, personal computers, personal digital assistant (PDA) devices, tablet computers, wearable computing devices, smartphones, internet appliances, and/or other types of computing devices. Moreover, while it is possible that the entirety of the system 500 shown in FIG. 5 is implemented within a downhole tool, it is also contemplated that one or more components or functions of the system 500 may be implemented in wellsite surface equipment. As shown in the embodiment illustrated in FIG. 5, the processing system 500 may include one or more processors (e.g., processors 502A-502N), a memory 504, I/O ports 506 input devices 508, output devices 510, and a network interface 512. The processing system 500 may also include one or more additional interfaces 514 to facilitate communication between the various components of the system 500.

The processor 502 may provide the processing capability to execute programs, user interfaces, and other functions of the system 500. The processor 502 may include one or more processors and may include “general-purpose” microprocessors, special purpose microprocessors, such as application-specific integrated circuits (ASICs), or any combination thereof. In some embodiments, the processor 502 may include one or more reduced instruction set (RISC) processors, such as those implementing the Advanced RISC Machine (ARM) instruction set. Additionally, the processor 502 may include single-core processors and multicore processors and may include graphics processors, video processors, and related chip sets. Accordingly, the system 500 may be a uni-processor system having one processor (e.g., processor 502a), or a multi-processor system having two or more suitable processors (e.g., 502A-502N). Multiple processors may be employed to provide for parallel or sequential execution of the techniques described herein. Processes, such as logic flows, described herein may be performed by the processor 502 executing one or more computer programs to perform functions by operating on input data and generating corresponding output. The processor 502 may receive instructions and data from a memory (e.g., memory 504).

The memory 504 (which may include one or more tangible non-transitory computer readable storage mediums) may include volatile memory and non-volatile memory accessible by the processor 502 and other components of the system 500. For example, the memory 504 may include volatile memory, such as random access memory (RAM). The memory 504 may also include non-volatile memory, such as ROM, flash memory, a hard drive, other suitable optical, magnetic, or solid-state storage mediums or any combination thereof. The memory 504 may store a variety of information and may be used for a variety of purposes. For example, the memory 504 may store executable computer code, such as the firmware for the system 500, an operating system for the system 500, and any other programs or other executable code for providing functions of the system 500. Such executable computer code may include program instructions 518 executable by a processor (e.g., one or more of processors 502A-502N) to implement one or more embodiments of the present disclosure, such as determining GOR in accordance with the techniques described above. Program instructions 518 may include computer program instructions for implementing one or more techniques described herein. Program instructions 518 may include a computer program (which in certain forms is known as a program, software, software application, script, or code).

The interface 514 may include multiple interfaces and may enable communication between various components of the system 500, the processor 502, and the memory 504. In some embodiments, the interface 514, the processor 502, memory 504, and one or more other components of the system 500 may be implemented on a single chip, such as a system-on-a-chip (SOC). In other embodiments, these components, their functionalities, or both may be implemented on separate chips. The interface 514 may enable communication between processors 502a-502n, the memory 504, the network interface 512, any other devices of the system 500, or a combination thereof. The interface 514 may implement any suitable types of interfaces, such as Peripheral Component Interconnect (PCI) interfaces, the Universal Serial Bus (USB) interfaces, Thunderbolt interfaces, Firewire (IEEE-1394) interfaces, and so on.

The system 500 may also include an input and output port 506 to enable connection of additional devices, such as I/0 devices 508 and 510. Embodiments of the present disclosure may include any number of input and output ports 506, including headphone and headset jacks, universal serial bus (USB) ports, Firewire (IEEE-1394) ports, Thunderbolt ports, and AC and DC power connectors. Further, the system 500 may use the input and output ports to connect to and send or receive data with any other device, such as other portable computers, personal computers, printers, etc.

The processing system 500 may include one or more input devices 508. The input device(s) 508 permit a user to enter data and commands used and executed by the processor 502. The input device 508 may include, for example, a keyboard, a mouse, a touchscreen, a track-pad, a trackball, an isopoint, and/or a voice recognition system, among others. The processing system 500 may also include one or more output devices 510. The output devices 510 may include, for example, display devices (e.g., a liquid crystal display or cathode ray tube display (CRT), among others), printers, and/or speakers, among others.

The system 500 depicted in FIG. 5 also includes a network interface 512. The network interface 512 may include a wired network interface card (NIC), a wireless (e.g., radio frequency) network interface card, or combination thereof. The network interface 512 may include known circuitry for receiving and sending signals to and from communications networks, such as an antenna system, an RF transceiver, an amplifier, a tuner, an oscillator, a digital signal processor, a modem, a subscriber identity module (SIM) card, memory, and so forth. The network interface 512 may communicate with networks, such as the Internet, an intranet, a cellular telephone network, a wide area network (WAN), a local area network (LAN), a metropolitan area network (MAN), or other devices by wired or wireless communication using any suitable communications standard, protocol, or technology.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way used for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense and not for purposes of limitation.

What is claimed is:

1. A method for determining a composition and gas/oil ratio of a fluid, comprising:
quantifying a plurality of components of a fluid sample from measurements obtained from a gas chromatogram adapted to receive a first portion of the fluid sample and from an optical analyzer adapted to receive a second portion of the fluid sample, wherein the plurality of components comprises light components and intermediate components;
determining a mass fraction for each light component of the plurality of components;
determining a mass fraction for each intermediate component of the plurality of components;
determining a gas/oil ratio of the fluid sample from the mass fraction of each light component, the mass fraction of each intermediate component, a molecular weight of each light component, a molecular weight of each intermediate component, the density of stock tank oil, the vapor mass fraction of the intermediate components, and the mass fraction of a plus fraction determined from the fluid sample.

2. The method of claim 1, wherein the light components comprise CO2, N2, H2S, C1, and C2.

3. The method of claim 1, wherein the intermediate components comprise C3, C4, C5, C6, and C7.

4. The method of claim 1, wherein the plus fraction comprises components heavier than C7.

5. The method of claim 1, comprising determining the vapor mass fraction of the intermediate components and the density of stock tank oil.

6. The method of claim 5, wherein determining the vapor mass fraction of the intermediate components and the density of stock tank oil comprises performing a flash calculation to calculate vapor mass fraction of the intermediate components and the density of stock tank oil.

7. The method of claim 1, wherein determining a gas/oil ratio of the fluid sample from the mass fraction of each light component, the mass fraction of each intermediate component, a molecular weight of each light component, a molecular weight of each intermediate components, the density of stock tank oil, and the vapor mass fraction of the intermediate components comprises calculating the gas/oil ratio using the formula:
$$GOR = \frac{23.69 {d}_{sto} ( {\sum }_{l} \frac{{m}_{l}}{{M}_{l}} + {f}_{g} {\sum }_{i} \frac{{m}_{i}}{{M}_{i}} )}{( 1 - {f}_{g} ) {\sum }_{i} {m}_{i} + {m}_{n +}}$$
Where GOR is the gas/oil ratio, dₛₜₒ is the stock tank oil (STO) density at standard conditions, mₙ₊ is the mass fraction of a plus fraction, mₗ is the mass fraction of the light components, Mₗ is the molecular weight of the light components, mᵢ is the mass fraction of the intermediate components, Mᵢ is the molecular weight of the intermediate components and f_{g} is the vapor mass fraction of the intermediate components.

8. The method of claim 1, comprising determining the vapor mass fraction from the vapor mole fraction.

9. A method for determining a composition and a gas/oil ratio of a fluid, comprising:
quantifying a plurality of components of a fluid sample from measurements obtained from a gas chromatogram adapted to receive at least a first portion of the fluid sample and from an optical analyzer adapted to receive at least a second portion of the fluid sample, wherein the plurality of components comprises light components and intermediate components;
determining a gas/oil ratio of the fluid sample from the density of stock tank oil, the vapor mole fraction of the intermediate components, and the molecular weight of stock tank oil.

10. The method of claim 9, wherein the light components comprise CO2, N2, H2S, C1, and C2.

11. The method of claim 9, wherein the intermediate components comprise C3, C4, C5, C6, and C7.

12. The method of claim 9, comprising determining the vapor mole fraction of the intermediate components, the density of stock tank oil, and the molecular weight of stock tank oil.

13. The method of claim 12, wherein determining the vapor mass fraction of the intermediate components and the density of stock tank oil comprises performing a flash calculation to calculate vapor mass fraction of the intermediate components and the density of stock tank oil.

14. The method of claim 9, wherein determining a gas/oil ratio of the fluid sample from the density of stock tank oil, the vapor mole fraction of the intermediate components, and the molecular weight of stock tank oil comprises calculating the gas/oil ratio using the formula:
$$GOR = \frac{23.69 {n}_{g} {d}_{sto}}{( 1 - {n}_{g} ) {M}_{sto}}$$
Where n_{g} is the vapor mole fraction of the intermediate components, Mₛₜₒ is the molecular weight of stock tank oil, and dₛₜₒ is the stock tank oil (STO) density at standard conditions.

15. A system comprising:
one or more processors;
a non-transitory tangible computer-readable memory coupled to the one or more processors and having executable computer code stored thereon, the code comprising a set of instructions that causes one or more processors to perform the following:
quantifying a plurality of components of a fluid sample from measurements obtained from a gas chromatograph adapted to receive at least a first portion of the fluid sample and from an optical analyzer adapted to receive at least a second portion of the fluid sample, wherein the plurality of components comprises light components and intermediate components; and
determining a gas/oil ratio of the fluid sample from the density of stock tank oil, the vapor mole fraction of the intermediate components, and the molecular weight of stock tank oil.

16. The system of claim 15, comprising a fluid analysis tool comprising the gas chromatograph and the optical analyzer.

17. The system of claim 15, wherein the fluid analysis tool is inserted in wellbore of a well and is configured to acquire the fluid sample.

18. The system of claim 15, wherein the light components comprise CO2, N2, H2S, C1, and C2.

19. The system of claim 15, wherein the intermediate components comprise C3, C4, C5, C6, and C7.

20. The system of claim 15, wherein determining a gas/oil ratio of the fluid sample from the density of stock tank oil, the vapor mole fraction of the intermediate components, and the molecular weight of stock tank oil comprises calculating the gas/oil ratio using the formula:
$$GOR = \frac{23.69 {n}_{g} {d}_{sto}}{( 1 - {n}_{g} ) {M}_{sto}}$$
Where n_{g} is the vapor mole fraction of the intermediate components, Mₛₜₒ is the molecular weight of stock tank oil, and dₛₜₒ is the stock tank oil (STO) density at standard conditions.
